(19) United States
(12) Patent Application Publication
(10) Pub. No.: US 2002/0156653 A1
(43) Pub. Date: Oct. 24, 2002

(54) System and method for prescribing unregulated therapeutic substances in an integrated medical health care program

(75) Inventors: Vito V. Florio, Coral Springs, FL (US); Richard L. Michaels, Largo, FL (US)

Correspondence Address: MASON & ASSOCIATES, PA, 17757 US HWY 19 N., SUITE 500, CLEARWATER, FL, 33764, US

(73) Assignee: National Health Essentials, Inc.

(21) Appl. No.: 09/955,598

(22) Filed: Sep. 18, 2001

Related U.S. Application Data
(63) Continuation-in-part of application No. 09/837,490, filed on Apr. 18, 2001.

(51) Int. Cl. G06F 17/60

(52) U.S. Cl. 705/3

(57) ABSTRACT

A natural health integrated medical program and method for coordinated prescription of unregulated therapeutic substances in a supervised medical environment, wherein the unregulated therapeutic substances, derived from natural products, are initially documented and qualified as a therapeutic option to traditional prescription and over-the-counter medicines. The implementation of the program and method of qualification and prescription of unregulated therapeutic substances is performed within the context of a mainstream medical care environment comprising a Medical Care Entity, wherein patients within a given system, elect to participate in the program under the supervision of the medical professional responsible for their care. Upon initial successful completion of the program, the patient is empowered, with the medical professional's approval, to adopt the unregulated therapeutic substances for treatment of his/her illness or condition.

### RELATED APPLICATION

This application is a continuation-in-part of application Ser. No. 09/837,490 filed Apr. 18, 2001.

This invention, which is more fully described in detail below, relates to system and method for prescribing unregulated therapeutic substances and nutritional supplements (collectively “Nutraceuticals” or “Natural Therapeutics” or “Natural Supplementations”) in an integrated medical health care program, as an equivalent or superior treatment option to traditional ethical pharmaceuticals and/or over-the-counter medicines, within a supervised/mainstream medical care environment, that is, within medical care entities. This invention also contemplates the integration of the system of this invention within existing medical insurance plans and managed health care provider sponsored programs, which as contemplated by the invention are considered health care or managed health care entities.

The increasing publicity and recognition of unregulated herbal remedies and nutritional supplements, as equivalent or superior therapeutics to ethical pharmaceuticals, has and continues to create both promise and concerns. More specifically, in virtually all cultures a number of herbal remedies and nutritional supplements have been validated as an acceptable method for treatment of various illnesses or conditions. More specifically, the nutritional supplement, Vitamin C, have now been generally recognized as a prophylactic for the prevention and/or relief of the symptoms of the common cold. Similarly, herbal remedies, such as Echinacea has been recognized for its effectiveness in boosting the immune system; and Green Tea extract in the prevention/reduction of the incidence of breast cancer.

Both the European and Asian cultures have been, and continue to be, the primary focus of naturally derived substances that are currently receiving increasing acceptance in western cultures. More specifically, in western Europe (particularly in Germany, Netherlands, Sweden), herbal therapeutics and nutritional supplements are recognized by mainstream medicine as both viable and effective alternatives to the ethical pharmaceutical preparations. Such acceptance has been slow in coming within the United States because of medical establishment's resistance and regulatory biases. Moreover, because such substances are “unregulated” in the sense that they do not require FDA approval for marketing in the USA, generally only a limited amount of data is available and accessible to support the safety and efficacy claims made for such products. Moreover, since these products are derived and/or extracted from naturally occurring substances, their potency and dosage can vary within broad limits and, thus, the potential for inconsistency in treatment or, alternatively, overdose is ever present. In addition, since only a limited amount of experience has been documented with a number of these substance, their potential for interaction with other herbals and/or prescription drugs, is for the most part, still unknown.

Increasingly, as both herbal remedies and nutritional supplements, that is, “Nutraceuticals”, become more accepted and more readily accessible to the public through health food stores, pharmacies, and web-sites devoted to natural medicines, individuals having chronic disorders and/or limited funds for prescription medicines, have increasingly begun administering these products to themselves with imperfect knowledge as to their efficacy and individual safety. The safety concern is most pronounced in the seniors' community where such Nutraceuticals are generally taken by an individual who is suffering from multiple medical/aging disorders, and in conjunction with other pharmaceutical medicine for such pathologies.

Unfortunately, the medical establishment in the United States has been slow to embrace changes in traditional medical practice, and in many instances has exhibited hostility, to new and “unregulated” remedies such as Nutraceuticals. As noted above, one of the primary criticisms and concerns by the medical professional has and continues to be the absence of credible clinical data, the absence of established standards relative to dosage and variation in quality depending upon the source and the manner of extraction/purification/compounding, etc. The medical professional's reluctance to embrace such natural therapeutics is in no small measure based upon a well-founded concern for his/her potential professional liability for prescription of such Nutraceuticals.

Notwithstanding, the increasing recognition of the potential for good that such Nutraceuticals may have for individuals with chronic illness/disorders, without some means for prescription, delivery and supervision of the administration of such Nutraceuticals within a main stream medical care provider environment, their availability will continue to be limited to the dispensing thereof by non-medical personnel in an unsupervised environment. As such distribution and use continues to expand, the potential for harm and increasing pressure for regulatory restriction will grow.

Further, the resistance of the Nutraceutical industry to government imposed standards, and manifest lack of interest in self-regulation, has and continues to create distrust and confusion among medical professionals, and to create resistance to prescription of such natural therapeutics because of the uncertainties in their safety and effectiveness.

Thus, there continues to exist both a need to fully exploit naturally derived Nutraceuticals which, although largely undocumented, have proven efficacious, while at the same time protecting the uneducated individual from making an uniformed decision as to one or more of these natural therapies. Of equal importance to accomplish this dual objective within mainstream medicine is to insure proper surveillance of the patient reactions and progress, while at the same time increasing the availability of such treatments through various forms of Medical Care Entities, including clinics, hospitals, private medical practices, Managed Health Care Entities administering medical insurance and managed health care reimbursement programs, etc. The requirement for mainstream medical care provider/entity involvement is essential both to protect the patient and to avoid additional regulatory restriction on the availability of such natural products, which, if it occurs, can only increase their cost and reduce their availability.

The invention provides for a prescription system and method for unregulated Nutraceutical (therapeutic) compounds within a mainstream medical care environment, wherein a medical professional is involved throughout the qualification of a patient as a candidate for an equivalent or superior therapy for treatment of such illness or medical disorder/condition. It is in effect an Integrative Medicine Health Care Program. The medical professional and patient are integrally involved throughout the pathology process of the safety and effectiveness of a natural therapy for treatment of patients suffering from an illness or medical disorder.

The invention further provides for the continuing education of the medical professional and the patient relative to natural therapy choices specific for the patient's illness/disorder to further encourage patient and physician understanding and involvement in such equivalent or superior natural treatment options.

Generally, the invention is an Integrative Medicine Health Care Program for prescribing unregulated therapeutic substances as an equivalent or superior treatment option to traditional pharmaceuticals and/or over-the-counter medicines within a mainstream medical care environment comprising:

a mainstream medical care environment comprising a Medical Care Entity staffed by one or more medical professionals having responsibility for treatment of patients with traditional medicines, natural therapeutics, nutritional supplements and combinations thereof, for a given medical condition;

means for identification of an unregulated therapeutic substance as a natural treatment for said given medical condition within said Medical Care Entity;

means for alerting said Medical Care Entity and its one or more medical professionals responsible for overseeing the care of said patients for said given medical condition, of the availability within the Program of said unregulated therapeutic substance as the natural treatment of the given medical condition;

means for soliciting said one or more medical professionals and their patients diagnosed with said given medical condition, to participate in the Program with the initiation of a treatment protocol for said unregulated therapeutic substance;

means for qualifying said patients in said Medical Care Entity for participation in the Program; and

means for administering said unregulated therapeutic substance to said qualified patients in accordance with a natural therapeutic treatment regimen, under the supervision of said Medical Care Entity,

wherein said unregulated therapeutic substance is obtained by the patient for administering to said patient by a prescription provided by the Medical Care Entity, and

wherein the administering of the unregulated therapeutic substance is administered as part of an integrative medical protocol within the mainstream medical care environment.

The administering of the unregulated therapeutic substance is administered as part of the integrative medical protocol within the mainstream medical care environment as an appropriate primary mode of treatment.

The administering of the unregulated therapeutic substance is also administered as part of the integrative medical protocol within the mainstream medical care environment as an appropriate complimentary and alternative mode of treatment.

The Program further comprises means for monitoring patient response to said unregulated therapeutic substance, within said Medical Care Entity.

Each qualified patient is empowered to specify said unregulated therapeutic substance as a natural treatment for said qualified patient's given medical condition.

The Program further comprises means for disseminating to the Medical Care Entity and its patients up-to-date technical and product information related to said unregulated therapeutic substance as a natural treatment for said given medical condition.

The Program further comprises means for supplying said unregulated therapeutic substance to patients pursuant to the prescription for said unregulated therapeutic substance issued by the Medical Care Entity.

The means for supplying said unregulated therapeutic substance to patients pursuant to the prescription for said unregulated therapeutic substance issued by the Medical Care Entity is a Nutraceutical Supplier of the unregulated therapeutic substance.

The Nutraceutical Supplier constitutes and is recognized by the Medical Care Entity and in the Program as a sole source designated Brand Name Nutraceutical Supplier from whom the prescription is filled.

The Medical Care Entity includes private medical practices, hospitals, established health care providers such as an HMO and PPO, Insurance Company Sponsored Plans, Union Sponsored Plans administered by a professional health care service provider and government agencies.

The Nutraceutical Supplier maintains fully documented natural therapeutic records, including, certificates of analysis on each unregulated therapeutic substance and completed documentation related to each unregulated therapeutic substance's efficacy and safety.

The Nutraceutical Supplier further provides administrative and support services and education and information services to the Medical Care Entity and the established health care providers.

The means for identification of the unregulated therapeutic substance as the natural treatment for the given medical condition is by the Medical Care Entity identifying such unregulated therapeutic substance from one of the administrative and support services, the education and information services, and a combination thereof, provided by the Nutraceutical Supplier.

The Program Nutraceutical Supplier alerts the Medical Care Entity of the availability of the unregulated therapeutic substance as the natural treatment of the given medical condition.

The Nutraceutical Supplier further supports the Program by providing educational tools, to the Medical Care Entity, the one or more medical professionals responsible for the patients participating in the Program, and to the patients themselves, the educational tools being in the form of an Internet based service that would provide answers to user questions, and in the form of searchable database services, including technical reference articles, related to the natural therapeutics and nutritional supplements, to alert the one or more medical professionals and patients to contra indications and potential interactions between the natural treatment for the given medical condition and the prescription for the unregulated therapeutic substance.

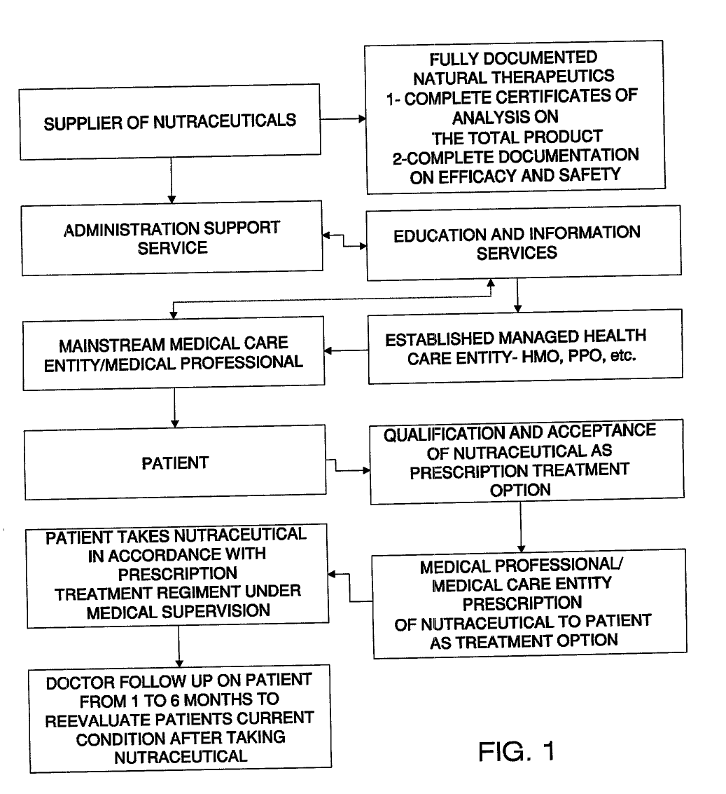

FIG. 1 is an illustration of a general overview of the invention process.

Referring to FIG. 1, which as stated provides the general overview of the inventive process, the invention provides for a prescription system and method for qualification, administration, education, and distribution of natural therapeutic substances or nutritional supplements (herein also collectively “Nutraceuticals”), in a novel treatment regimen for a given illness or condition, as an equivalent or superior to traditional treatment regimens with ethical pharmaceuticals and over-the-counter medications.

In the system and method of the invention, an established Medical Care Entity, which includes clinics, hospitals, private medical practices, and Managed Health Care Entities initiates a program of Nutraceuticals within its existing population of patient subscribers, also referred to herein as patients, under the medical supervision of one or more medical professionals responsible for treatment of patient subscribers within the established medical care provider system. As noted above, an established Medical Care Entity includes Managed Health Care Entities such as Health Maintenance Organization (HMO) or Preferred Provider Organization (PPO), an Insurance Company Sponsored Medical Reimbursement Plan (ICSP), a Union Sponsored Medical Plan or a Government Agency. Such medical Care Entity would initially identify a number of patients; solicit patient interest in participation in the Natural Health Integrative Medical Program (PROGRAM) utilizing Nutraceuticals as an equivalent or superior to traditional treatment regimens presently being prescribed for medical management of the patients' condition or illness; and initiate the Nutraceutical treatment protocol on the selected patients under the supervision of the medical professionals responsible for the medical management of the illness/disorder of the patient subscribers under their care. The medical professional would be provided with a Nutraceutical of a known quality and potency from a reputable source or sole source or brand name source Supplier, to be administered in accordance with the established protocol to the selected patient subscribers under their care. The medical professional would be responsible for monitoring of the patient's progress, and reactions to the Nutraceutical, which would be noted and reported to the entity responsible for administration of the program.

Moreover, the anticipated increase in patient involvement, specifically, the access to educational materials and feed-back on his/her specific pathology would encourage individual participation. The educational tools provided to both the medical professional and to the patient would be designed to create a patient awareness program of the dangers of self-medication, thus discouraging patient experimentation with potentially harmful products in an unsupervised environment. The benefits attainable from this approach include better medicine, less risk to the patient and lower cost to the medical care entity.

In one of the preferred embodiments of this invention, the Nutraceutical Supplier would support the PROGRAM by providing educational tools, to both the one or more medical professionals and Medical Care Entity responsible for the patients participating in the PROGRAM, and to the patients themselves. These tools would preferably be in the form of an Internet based service, that is a website, that would provide answers to user questions; and searchable database services, including technical reference articles related to the natural therapeutics and nutritional supplements, to alert the medical professional and patient to contra indications and potential interactions between the natural therapy and prescription medication.

In another of the preferred embodiments of this invention, the administration of the PROGRAM Nutraceutical would involve the implementation of an interactive network between the participants, specifically, the established Medical Care Entity who initiates and is actively monitoring the results of the evaluation, the medical professional who is supervising the PROGRAM, and the Nutraceutical Supplier who is supporting both the Medical Care Entity, the medical professional and the patient with educational tools and products. Accordingly, each of these participants cooperates and supports the patients enrolled in the PROGRAM in their own unique way; and upon satisfactory completion of the diagnostic work-up, makes such Nutraceutical available by prescription to the enrolled plan participants. The use of the prescription process in administration of the Nutraceuticals is a critical feature of the system and method of this invention, both from the perspective of the medical professional, and from the perspective of the patient, because such process necessarily gains medical professional recognition of the efficacy of the natural therapeutic, in the writing of the prescription; and patient recognition that such natural therapeutics are both potent and a potentially harmful substances that cannot be dispensed or taken other than under medical supervision to protect the patient's well-being.

It is within the scope of the invention that the Nutraceutical Supplier provides the medical professional and Medical Care Entity with the resources to exercise quality control over the patient practice to discourage self-medication and fad use of supplements and herbals through the Nutraceutical Supplier's information resources such as its website, education programs, diagnostic instrumentation and support services.

Moreover, by adoption of the prescription process for distribution of the Nutraceutical, the medical establishment, e.g., medical professional and Medical Care Entity now can professionally control the qualification and administration of the natural therapeutic within a defined population, consistent with the safeguards of mainstream medical practice.

The enrolled plan participants who elect to take the Nutraceutical are monitored, as before, by the medical professional responsible for overseeing their care; and their progress and any reactions recorded within the database maintained by the Medical Care Entity and the entity providing the administrative support services, which typically may be the Supplier. These data are available to all appropriate database subscribers to confirm efficacy, safety, cost effectiveness, and to alert them to any side-effects or interactions involving the natural therapeutics, pharmaceuticals and biologicals. Data may be obtained in a number of ways. One method contemplated as within the scope of the invention is the filling out of a Nutritional Questionnaire, a form which the Nutriceutical Supplier could supply to medical professionals and Medical Care Entities. The Questionnaire would typically be filled out by the patient on their first interface with the educated medical professional or Medical Care Entity. The Questionnaire becomes a permanent part of the patient charts, gives initial feedback to the medical professional as to which natural supplements (Nutriceuticals) the patient is currently taking or has taken within the last year.

In addition, as new or improved Nutraceuticals are developed and become available, database subscribers, the medical professional and the Medical Care Entity would be alerted to such developments. The importance of the medical professional's role in this process cannot be over emphasized. In addition to creating new fee-for-service options, the professional now has the potential for expansion of the patient base by attracting new patients that have become disenchanted with their current/traditional treatment options, or who simply would prefer treatment in a medically supervised environment with a naturally occurring/derived therapeutic rather than the present system.

At each stage of the PROGRAM and prescription process, the medical professional is encouraged to become involved in the search for natural therapeutics, and compensated for his/her efforts for his re-education, and in the education of the enrolled plan participants under his care. The increased involvement of the medical professional in his own re-education, and in the decision making process, as to identification and consideration of natural therapeutics, shall progressively increase the availability of natural treatment options, and lower the cost of medication. One advantage of the natural therapeutic program, as contemplated by this invention, is that the successful administration of the program can reduce the physiological load and stress upon the body's cleansing processes (kidneys and liver) required for clearance of synthetic medicine, and the by-products of such synthetic medicines, resulting in lower negative side-effects. Another advantage is that it offers an option to a patient who is refractoring from conventional pharmaceutical therapy.

In order to fully appreciate the context of this invention, and benefits to be derived from its implementation within an established Managed Health Care Entity such as a Health Maintenance Organization (HMO), or comparable medical care service provider (PPO, Insurance Company Sponsored Plan, Union Sponsored Plan administered by a professional health care service provider, government agency such as a Public Health Hospital, the Veterans Administration, Department of Defense clinics and hospitals, etc.), one must appreciate that past efforts at utilization of a systems approach to managed health care/medical practice has been resisted because of its perceived encroachment upon the physician/patient relationship, specifically, the independence of the physician in directing patient care. Accordingly, for any systems approach to delivery of medical services, within a managed health care environment, to be acceptable and recommended or endorsed by the mainstream medicine practitioner, it must first defer to the independent professional judgement of the physician in the formulation of the patient's care; recognize and respect the patient preferences in the selection of the treatment regimen for his illness or condition; and, be cost effective so as to reduce the cost of health care and the insurance premiums paid by the patient, or his employer.

The system and method of this invention can be defined in terms of a hierarchical structure that is tailored for coordinated integrated interactions between the Nutraceutical Supplier and mainstream medical professionals to qualify and initiate treatment protocol on selected patients by prescribing and administering natural products and/or naturally derived products, in the nature of natural therapeutics, that is, the so-called “Nutraceuticals”, within the mainstream medical environment. In addition, because such system and method are implemented within an established medical care provider environment, medical professional involvement is assured for continuity of patient care; and patient self-administration of an unregulated substance or unknown quality and potency, is discouraged.

In, for example, the managed care environment through its employees and medical professionals under contract to a Managed Health Care Entity, provide professional medical services to its patient subscribers, and compensate the medical professional based upon a set reimbursement schedule. The managed care environment defined system of health care, lists various treatment options and medications, suitable for physician prescription, which are reimbursable by the Managed Health Care Entity. Generally, both the medical professional and patient subscriber options are constrained by the Managed Health Care Entity, and the absence of such options is driven by the Managed Health Care Entity's desire to contain the cost of medical care. As set forth herein, this invention furthers the Managed Health Care Entity's objectives of cost containment, while at the same time expands the treatment options available to the medical professionals and the patient subscribers, within the managed health care system, through the introduction of therapeutics, based upon natural substances and derivatives of natural substances, the Nutraceuticals.

In the preferred embodiments of this invention illustrated in FIG. 1, the system and method of this invention is shown implemented within an established mainstream patient care treatment system administered through a Medical Care Entity. The system and method of this invention includes, as a participant, a Supplier of quality natural therapeutics and nutritional supplements. It is contemplated that this Supplier be a Brand Name Supplier, such as National Health Essentials, Inc., a Florida Corporation, to ensure quality of the natural products being distributed. For the purposes of this illustration, the Medical Care Entity utilizes the professional services of its medical professional staff and/or medical professionals to provide medical services to the patient. The system assumes that each of the participants' self-interests are the primary motivational forces to both participation and to the success of the system. As noted herein, additional incentives to participation are available where needed or desirable to generate interest in this evolutionary approach to medical management of disease and disorders. Upon evaluation and qualification of a Nutraceutical as a prescription option to physician and patient, the medical professional can prescribe the Nutraceutical in accordance with a therapeutic regimen, for medical management of the patients illness and/or disorder.

FIG. 1 further illustrates the interaction between the Supplier, the Medical Care Entity, including the medical professional, and the patient in the qualification of the patient to participate in the PROGRAM through the ultimate acceptance of the Nutraceutical as a therapeutic prescription option of first choice in the treatment of the patient. In one of the contemplated embodiments of this invention, such interaction is represented as a series of protocols, leading ultimately to the rejection or acceptance of the Nutraceutical as a prescription option.

Initially, the Medical Care Entity, which can be a Managed Health Care Entity, such as an HMO, either independently, or with the assistance of a Nutraceutical Supplier, identifies therapeutic candidates that have been documented as an equivalent or superior treatment option to traditional prescription and/or over-the-counter medications. Having made such initial identification, the Medical Care Entity independently, or with the assistance of a medical professional, establishes a protocol for distribution of the natural therapy within the patient population of the Medical Care Entity.

Subsequent thereto, the Medical Care Entity, or its designee, contacts the medical professional responsible for care of the patient, whose treatment could potentially benefit from the Nutraceutical, to elicit potential interest in participation in the PROGRAM of the natural therapeutic. Alternatively, the Medical Care Entity can contact its patient directly, or contact both the medical professional and the patient at about the same time, and encourage the setting of an appointment to discuss the natural therapeutic of potential benefit to the patient.

The medical professional would then qualify the patient expressing interest in the natural therapeutic as a participant in the PROGRAM. This involves confirming or updating the patient history, and initiation of a series of state-of-the-art diagnostic tests to verify the patient health status preliminary to his/her enrollment and participation in the PROGRAM. The creation of a patient subscriber profile may, under certain circumstance, disqualify a patient from participation in the PROGRAM, or mandate the prescription of supplements in conjunction with the natural therapeutic. Thus, preliminary to such natural therapeutic participation, the medical professional would initially address the patient's current in-take of essential nutrients and supplements.

Assuming a sufficient number of patients are qualified to participate in the PROGRAM, each patient would be provided with a prescription, much in the same manner as a prescription for traditional pharmaceuticals. The prescription would identify the Nutraceuticals by brand name, the dose and the dosage form, and the therapeutic regimen (frequency of administration) for the prescribed natural therapeutic. The patient would fill the prescription either through the medical professional's office or Medical Care Entity, or directly from the Supplier, or some other entity participating in the PROGRAM, to insure integrity of the product used in the PROGRAM. The use of the prescription process in administration of the Nutraceuticals is a critical feature of the system and method of this invention, both from the perspective of the medical professional and from the perspective of the patient because such process results in the medical professional recognition of the efficacy of the natural therapeutic, and the patient recognizes that such natural therapeutics are potent substances, that must be administered with medical direction and supervision to protect the patient's well-being in the treatment of his/her illness and/or condition, and to protect against adverse reactions or interactions with other medicines. Thus, the medical professional and Medical Care Entity each accept the administration of the natural therapeutic as integral with mainstream medical practice, thereby eliminating the need and/or temptation for the patient to experiment with such natural therapeutics by self-administration.

In effect, the administering of the unregulated therapeutic substance is administered as part of an integrative medical protocol within the mainstream medical care environment. The administering may be an appropriate primary modality (mode of treatment), that is, the drug of first choice, or it may be an appropriate complimentary and alternative mode of treatment.

The progress of the patient would be monitored, and any reactions to the natural therapeutic noted by the medical professional responsible for the patient's care. The assessment of the Nutraceutical for both safety and efficacy by the medical professional could include traditional methods for maintaining surveillance of the patients' compliance with therapeutic regimen on the PROGRAM. For example, the patient monitoring can involve direct contact with the patient, e.g., periodic office visits, or interface with the patient via an info website, email, chat lines, telephone, eCommerce, etc., to confirm that the patient is adhering to the treatment regimen.

The monitoring is calculated to necessarily elicit information from the patient relative to changes in the medical condition and patient's overall medical status in regards to the natural therapy. In a typical application of the invention, the information is provided in response to a questionnaire that requests the patient answer specific questions related to nutritional health status. For example, where the natural therapeutic is a natural pain anti-inflammatory relief preparation for treatment of the symptoms associated with inflammation of joints, a question relating to the patient's subjective symptoms associated with “stiffness” may be appropriate. Similarly, the patient would also be requested to report on other symptoms associated with that condition or illness. The questionnaire could also elicit information as to any other changes in the patient's well being.

Both preliminary to, and at or about the time of initiation of the PROGRAM, each of the participants, specifically, the medical professional and the patient, would receive information relative to the natural therapeutic and the protocol contemplated by the Medical Care Entity. The information could also be distributed by and/or through the Medical Care Entity, and/or by the Supplier of the Nutraceuticals, to each of the medical professionals and patients identified by the Medical Care Entity.

In a typical application of the invention, in order to increase the medical professional's and the patient's familiarity with the natural therapeutic, each of these potential participants would be encouraged to independently access an information database on a website, or other source as described above, maintained by the Supplier of the Nutraceuticals. The website information would include a searchable database documentable information, including an email address and/or chat line, to answer questions that such individuals may have. Access could be provided on multiple levels, a professional level having more detailed technical articles, and a patient or layman level with information presented in a more readily understandable less technical format. In each instance, the maintenance of this information service would be the responsibility of the Supplier of the Nutraceuticals, who would periodically update the information available, based upon state of the art data from recognized authorities, and with topical literature with new product specifications, as it became available.

User access to, and familiarity with, the information services available on the website maintained by the Supplier of the Nutraceuticals, greatly simplifies the administration and support of the PROGRAM.

Within the limits of the protocol, the medical professional prescribes the Nutraceutical in accordance with a therapeutic regimen specific for the individual patient's needs; and thereafter, adjusts the treatment regimen, as appropriate, consistent with safety and efficacy objectives of the PROGRAM. The medical professional is solely responsible for the assessment of the patient reaction and progress to the natural treatment regimen.

Once the natural therapeutic has been qualified for prescription by the professionals affiliated with the Medical Care Entity, it is recommended for inclusion on the appropriate approved list of formularies of therapeutic medicines. Because of the previously noted lack of standards for such natural products, and the derivatives of the natural products, the prescription would only specify brand name products evaluated and endorsed by the Medical Care Entity, so as to insure efficacy, safety and cost effectiveness of the natural therapeutic dispensed to the Medical Care Entity's patients or patient subscribers.

At this juncture, active Medical Care Entity involvement in the process is essentially complete. The fulfillment of the prescription needs of the patient for the natural therapeutic is now administered by the Supplier of the Nutraceuticals, in cooperation with the medical professional, who can elect to either supply his patients directly or through referral of the patient to the Supplier's fulfillment house.

In one of the preferred embodiments of this invention, the Medical Care Entity and/or Supplier would maintain a tracking system to confirm patient prescription usage consistent with the therapeutic treatment regimen for the prescribed Nutraceuticals. More specifically, in each instance where a prescription is filled with the Nutraceuticals Supplier or at a fulfillment house, the medical professionals and/or the Medical Care Entity would monitor such activity, and confirm to the medical professional that the patient consumption of Nutraceutical is in compliance with his/her treatment regimen. This tracking system not only confirms the patient subscriber compliance with his prescribed natural treatment regimen, but also protects the Medical Care Entity and the medical professional from potential claims caused by a patient's departure from the prescribed treatment regimen.

As a result of the foregoing interactions, the relationship between the patient and medical professional has now been positively improved over that which existed before introduction of the PROGRAM's natural therapeutics into the treatment regimen. Such positive improvement is realized as incidental to the participatory nature of this interactive process wherein each of the participants is now participating in the decisions relating to the treatment options that are to be included within the available therapeutics and treatment regimens.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

Now that the invention has been described,

What is claimed is:

1. An Integrative Medicine Health Care Program for prescribing unregulated therapeutic substances as an equivalent or superior treatment option to traditional pharmaceuticals and/or over-the-counter medicines within a mainstream medical care environment comprising:
a mainstream medical care environment comprising a Medical Care Entity staffed by one or more medical professionals having responsibility for treatment of patients with traditional medicines, natural therapeutics, nutritional supplements and combinations thereof, for a given medical condition;
means for identification of an unregulated therapeutic substance as a natural treatment for said given medical condition within said Medical Care Entity;
means for alerting said Medical Care Entity and its one or more medical professionals responsible for overseeing the care of said patients for said given medical condition, of the availability within the Program of said unregulated therapeutic substance as the natural treatment of the given medical condition;
means for soliciting said one or more medical professionals and their patients diagnosed with said given medical condition, to participate in the Program with the initiation of a treatment protocol for said unregulated therapeutic substance;
means for qualifying said patients in said Medical Care Entity for participation in the Program; and
means for administering said unregulated therapeutic substance to said qualified patients in accordance with a natural therapeutic treatment regimen, under the supervision of said Medical Care Entity,
wherein said unregulated therapeutic substance is obtained by the patient for administering to said patient by a prescription provided by the Medical Care Entity, and
wherein the administering of the unregulated therapeutic substance is administered as part of an integrative medical protocol within the mainstream medical care environment.

2. The Program according to claim 1, wherein the administering of the unregulated therapeutic substance is administered as part of the integrative medical protocol within the mainstream medical care environment as an appropriate primary mode of treatment.

3. The Program according to claim 1, wherein the administering of the unregulated therapeutic substance is administered as part of the integrative medical protocol within the mainstream medical care environment as an appropriate complimentary and alternative mode of treatment.

4. The Program according to claim 1, further comprising:
means for monitoring patient response to said unregulated therapeutic substance, within said Medical Care Entity.

5. The Program according to claim 1, wherein each qualified patient is empowered to specify said unregulated therapeutic substance as a natural treatment for said qualified patient's given medical condition.

6. The Program according to claim 1, further comprising:
means for disseminating to the Medical Care Entity and its patients up-to-date technical and product information related to said unregulated therapeutic substance as a natural treatment for said given medical condition.

7. The Program according to claim 1, further comprising:
means for supplying said unregulated therapeutic substance to patients pursuant to the prescription for said unregulated therapeutic substance issued by the Medical Care Entity.

8. The Program according to claim 7, wherein the means for supplying said unregulated therapeutic substance to patients pursuant to the prescription for said unregulated therapeutic substance issued by the Medical Care Entity is a Nutraceutical Supplier of the unregulated therapeutic substance.

9. The Program according to claim 8, wherein the Nutraceutical Supplier constitutes and is recognized by the Medical Care Entity and in the Program as a sole source designated Brand Name Nutraceutical Supplier from whom the prescription is filled.

10. The Program according to claim 8, wherein the Medical Care Entity includes private medical practices, hospitals, established health care providers such as an HMO and PPO, Insurance Company Sponsored Plans, Union Sponsored Plans administered by a professional health care service provider and government agencies.

11. The Program according to claim 10, wherein the Nutraceutical Supplier maintains fully documented natural therapeutic records, including certificates of analysis on each unregulated therapeutic substance and completed documentation related to each unregulated therapeutic substance's efficacy and safety.

12. The Program according to claim 11, wherein the Nutraceutical Supplier further provides administrative and support services and education and information services to the Medical Care Entity and the established health care providers.

13. The Program according to claim 12, wherein the means for identification of the unregulated therapeutic substance as the natural treatment for the given medical condition is by the Medical Care Entity identifying such unregulated therapeutic substance from one of the administrative and support services, the education and information services, and a combination thereof, provided by the Nutraceutical Supplier.

14. The Program according to claim 8, wherein the Nutraceutical Supplier alerts the Medical Care Entity of the availability of the unregulated therapeutic substance as the natural treatment of the given medical condition.

15. The Program according to claim 13, wherein the Nutraceutical Supplier further supports the Program by providing educational tools, to the Medical Care Entity, the one or more medical professionals responsible for the patients participating in the Program, and to the patients themselves, the educational tools being in the form of an Internet based service that would provide answers to user questions, and in the form of searchable database services, including technical reference articles, related to the natural therapeutics and nutritional supplements, to alert the one or more medical professionals and patients to contra indications and potential interactions between the natural treatment for the given medical condition and the prescription for the unregulated therapeutic substance.
